(19) United States
(12) Patent Application Publication
(10) Pub. No.: US 2025/0278981 A1
(43) Pub. Date: Sep. 4, 2025

(54) METHOD AND SYSTEM FOR CONDUCTING WAGERING

(71) Applicant: Castle Island IP Holding LLC, Charlottesville, VA (US)

(72) Inventors: Daniel FULTON, Lancaster, PA (US); Alan ROIREAU, Charlottesville, VA (US); Jason SPRINKLE, Charlottesville, VA (US); Thomas ZAHORIK, Charlottesville, VA (US); Barry SCOTT, Charlottesville, VA (US)

(21) Appl. No.: 19/068,536

(22) Filed: Mar. 3, 2025

Related U.S. Application Data
(60) Provisional application No. 63/560,945, filed on Mar. 4, 2024.

(51) Int. Cl. G07F 17/32

(52) U.S. Cl. CPC G07F 17/3244; G07F 17/3225; G07F 17/329

(57) ABSTRACT

Gaming systems, machines, and methods are provided enabling variable gameplay using variable and/or dynamic reward values based on a continuation award evaluation. Continuation award evaluations may include awards assessed utilizing essential (i.e., numbers, patterns, daubs, etc.) and/or immaterial (i.e., color of card, shape of matching area, number of card, etc.) and/or supplemental (i.e., additional attributes of the ball call and/or bingo card such as added number, symbols, colors, etc.) elements of the bingo game. The continuation award evaluations may be distinct and independent from a principal result of a result index and/or from an end of a bingo game.

### CROSS-REFERENCE TO RELATED APPLICATIONS

This application further claims the benefit of and priority to U.S. Provisional Patent Application Ser. No. 63/560,945 filed on Mar. 4, 2024, entitled “Method and System for Conducting Wagering”, which is expressly incorporated herein by reference.

### FIELD OF THE DISCLOSURE

The field of the disclosure relates generally to a wagering game utilizing physical game elements such as cards, chips, etc. and/or virtual game elements such as provided in gameplay stations, wagering terminals, and gaming servers, including gaming consoles, gaming machines or networked gaming machines, such as gameplay stations, wagering terminals, and gaming servers found in casinos or betting environments, and related methods of operation.

### BACKGROUND

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming or in other words, wagering, in the United States is generally categorized into class I, class II and class III for the purposes of regulation, with class I gaming being defined as traditional tribal gaming subject to the least regulation, and class III gaming being subject to the greatest regulation and broadly encompassing all forms of gaming that are neither class I or II (e.g. casino or table games such as slot machines, blackjack, craps, roulette, etc.).

Class II gaming includes the game commonly referred to as bingo, whether or not electronic, computer, or other technological aids are used in connection with the game. In traditional bingo, players purchase cards that include different arrangements of tokens, such as numbers or other symbols, in a grid or other pattern. A caller randomly selects tokens from a token pool and players match the called tokens to their cards. When the matched tokens on a player's card form certain predetermined patterns or arrangements, such as a line, only corners, a completely filled card or other arrangement, the card may be identified as a winning card and scored accordingly, such that a corresponding reward or prize may be disbursed. A number of winning arrangements may be possible, such that a winning card may or may not conclude the game.

Unfortunately, despite the modernization of several aspects of class II gaming, further expansion of class II gaming is limited by regulatory constraints and traditional aspects of bingo.

In view of the foregoing, there is a need for improved gaming systems and methods that improve gameplay and management of class II games without losing the regulatory advantages associated with class II gaming. There is further a need for gaming systems and methods that enable the creation of new forms of gameplay for class II games, without increasing the processing requirements of a gaming terminal or gaming systems.

### SUMMARY

The embodiments disclosed herein are directed to providing improved gaming elements, systems and methods that address the problems above and enable an advantage of improved variability and enjoyment in class II gaming.

A set of bingo cards is provided, each bingo card of the set comprising a grid of bingo tokens and one or more supplemental elements in the form of a playing card, a casino chip, a roulette number, a color, and/or another feature of a table game, wherein the supplemental elements of each card are different.

A gaming system is provided including one or more gameplay stations and a gaming server. The gameplay stations may include a user interface and the gaming server may be provided in network communication with the one or more gameplay stations through a communications interface. The gaming server may comprise a memory and a processor configured for executing instructions stored on the memory to perform the following steps: receiving a gameplay request from the one or more gameplay stations, evaluating a continuation award for the gameplay request based on one or more of essential, immaterial, and/or supplemental elements of a bingo card, and determining an award value for the gameplay request based on the continuation award evaluation.

A method is provided comprising receiving a gameplay request from the one or more gameplay stations, evaluating a continuation award for the gameplay request based on one or more of essential, immaterial, and/or supplemental elements of a bingo card, and determining an award value for the gameplay request based on the continuation award evaluation.

These and other features of the disclosure will become better understood by reference to the following description, appended claims, and accompanying drawings.

### BRIEF DESCRIPTION OF THE DRAWINGS

FIG. 1 is a diagrammatic view of a continuation award evaluation according to an embodiment of the disclosure.

FIG. 2 is a diagrammatic view of a continuation award evaluation according to an embodiment of the disclosure.

FIG. 3 is a diagrammatic view of a continuation award evaluation according to an embodiment of the disclosure using color and layout of a bingo card.

FIG. 4A is a diagrammatic view of bingo cards having supplemental elements in the form of a playing card value and suite according to an embodiment of the disclosure.

FIG. 4B is a flow diagram of bingo cards having supplemental elements according to an embodiment of the disclosure.

FIG. 5 is a diagrammatic view of bingo cards having supplemental elements in the form of a roulette chip according to an embodiment of the disclosure.

FIG. 6 is a diagrammatic view of a continuation award evaluation according to an embodiment of the disclosure using essential elements of a bingo card.

FIG. 7 is a diagrammatic view of a continuation award evaluation according to an embodiment of the disclosure.

FIG. 8 is a diagrammatic view of a gaming system according to an embodiment of the disclosure.

FIG. 9 is a diagrammatic view of a gameplay station according to an embodiment of the disclosure.

FIG. 10 is a diagrammatic view of a gaming server according to an embodiment of the disclosure.

FIG. 11 is an illustration of an evaluation of a gameplay request according an embodiment of the present disclosure.

The figures are not necessarily drawn to scale, but instead are drawn to provide a better understanding of the components, and are not intended to be limiting in scope, but to provide exemplary illustrations. The figures illustrate exemplary configurations of a system and method for gaming, and in no way limit the structures, configurations, or methods of the system and method for gaming according to the present disclosure.

### DETAILED DESCRIPTION OF VARIOUS EMBODIMENTS

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay and rewards in existing gaming implementations and provide an improved experience for players. The disclosure outlines some example improvements and practical applications provided by the disclosed embodiments. These are just examples only and the embodiments are not limited to only these improvements.

As used in the present disclosure, a “local connection” or “local communications interface” is generally used to refer to a direct connection by means of a network, whether wired or wireless, or similar means that does not require or otherwise involve the use of an internet or other third-party data connection.

Embodiments of the current disclosure relate to a wagering game including continuation award evaluations in addition to primary awards of a primary game. Examples of the current disclosure may be provided in terms referring to a bingo game as a primary game and may incorporate a further secondary game, however there is no intention to limit the disclosure thereto. Rather, one of ordinary skill in the art will recognize the possibility of applying the same principles of embodiments of the current disclosure to alternative forms of gaming.

As referenced in the examples of the current disclosure, a “game,” “active game,” “existing game,” and/or “new game” may be used to refer to a bingo call or another set of parameters governing results of a wager. A player or gameplay request entering or being assigned to a game generally refers to applying the call associated with the game to a wager associated with the player or gameplay request.

Embodiments of the disclosure may be directed to games facilitated by an underlying primary game of bingo. Accordingly, a game may begin by a player providing a wager and receiving a bingo card including a different arrangement of tokens, for example corresponding to a player's purchase of a card and/or a wager amount. The player may initiate a game and may place a wager by any suitable method.

The bingo card may include a random selection and arrangement of tokens from a token pool and may be randomly selected from a plurality of cards or randomly generated. The game may further include a game call or ball call, including randomly selected tokens from a token pool or a randomly selected grouping of tokens, such as using a random number generator. When the tokens on the player's bingo card matching the ball call of the game form one of a plurality of certain predetermined patterns or arrangements correlating to a principal result of a result index, the bingo card may be identified as a winner and may be scored against the principal result of the result index such that a corresponding reward or loss may be disbursed to the player

Various forms of card assignment or selection are contemplated. The bingo cards may take varying forms, including a random arrangement of any number of tokens, symbols, numbers or otherwise, such as in a grid pattern, a line or other arrangement. For some embodiments, a continuation award evaluation may be specific to a card layout, such that the bingo cards may be provided in specific layouts and/or with specific tokens for defining supplemental elements of the cards. The card may be selected from a plurality of cards for assignment to the player or wager, or may be generated for assignment to the player or wager. For example, a bingo card may have the form of a standard bingo card comprising numbers arranged in a 5-by-5 grid. A visual mapping of the 5-by-5 bingo card could be mapped to a twenty-five element array, so adding supplemental or sequential daubing elements would simply elongate the array length. In like manner, a player may be provided with only one card per wager, or with a plurality of cards for one or more wagers.

It will be understood that the disclosed embodiments of bingo games are merely exemplary, and that features of the present disclosure may also extend to other games and the like. In varying embodiments, any possible patterns may be provided as principal results of the result index, with rewards varying according to the odds, difficulty, or based on another factor as would be understood from the current disclosure.

The game may end with a payout, beginning another wager, another round, a bonus game, and/or by reverting to additional options for the player.

Continuation award evaluations according to the current disclosure include awards assessed utilizing sequential daubing of essential (i.e., numbers, patterns, daubs, etc.) and/or immaterial (i.e., color of card, shape of matching area, number of card, etc.) and/or supplemental (i.e., additional attributes of the ball call and/or bingo card such as added number, symbols, colors, etc.) elements of the bingo game. The continuation award evaluations may be distinct and independent from the principal result of the result index and/or from the end of the bingo game. Sequential daubing may include the comparison of tokens elements and/or bingo card elements to one of a plurality of certain predetermined patterns or arrangements.

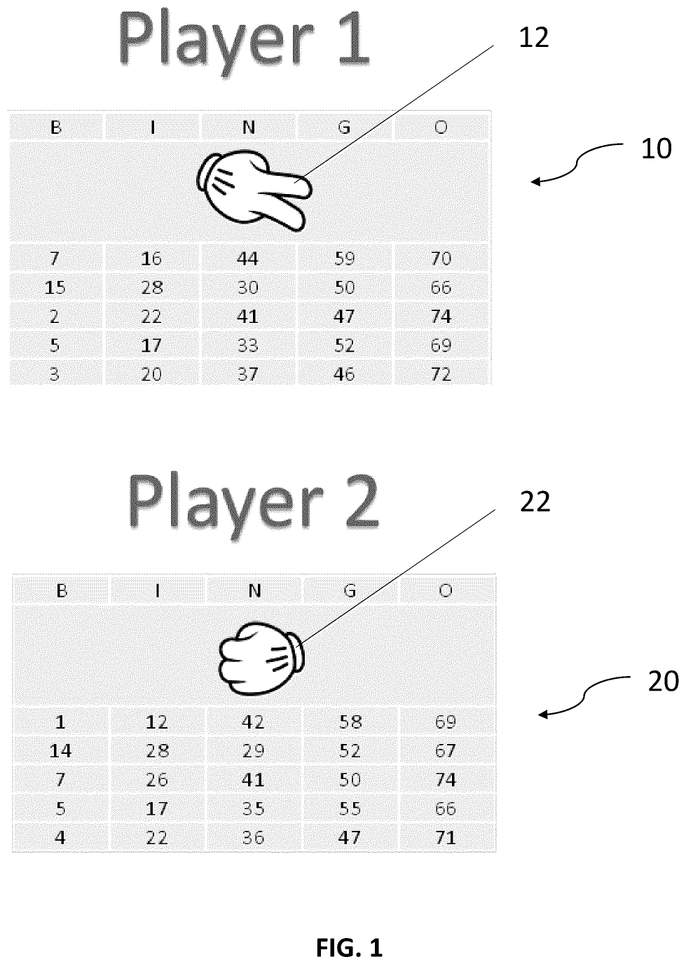

FIG. 1 illustrates an example of a continuation award evaluation in the form of a supplemental element of a bingo game comprising a rock-paper-scissors game. In the example of FIG. 1, a first player is provided with a first bingo card 10 and a second player is provided with a second bingo card 20, each bingo card comprising numbers arranged in a 5-by-5 grid as well as a supplemental element of a rock-paper-scissors game 12, 22. The continuation award evaluation may comprise a comparison of the supplemental element of the rock-paper-scissors game 12, 22 for each bingo card 10, 20 either against each other or a game “ball call” value. In the illustrated example, when evaluating the sequential daubing of continuation award between two cards against each other, player 2 “matches” the supplemental element of the bingo card, as “rock” 22 beats “scissors” 12. Therefore player 2 daubs their card in the given supplemental element spot 22 which can be evaluated to one of a plurality of certain predetermined patterns or arrangements.

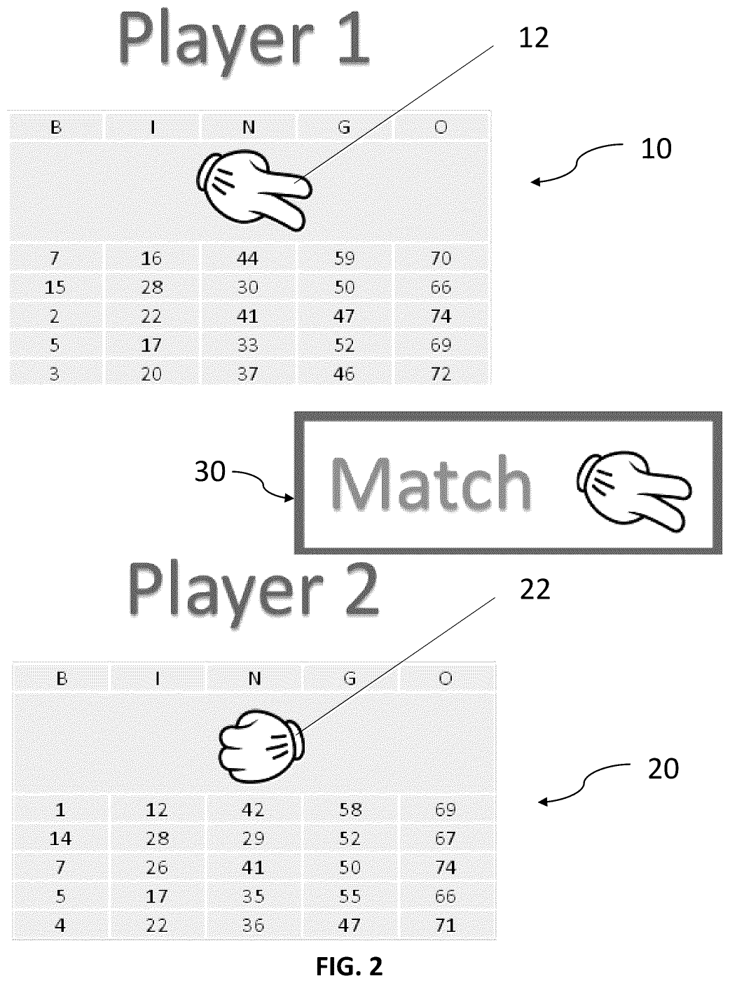

In a variation of the example of FIG. 1, FIG. 2 illustrates a continuation award evaluation including a match object 30. In the continuation award evaluation of FIG. 2, player 1 wins the match game because the supplemental element 12 matches the match object 30. Notably, the embodiments of FIG. 1 and FIG. 2 may be combined to create multiple continuation award evaluations, such as multiple winners where player 2 wins the rock-paper-scissors game and player 1 wins the match game. Alternatively, the embodiments of FIG. 1 and FIG. 2 may be combined as one continuation award evaluation where both a win in rock-paper-scissors and a match with the match object are required for a player to win a continuation award.

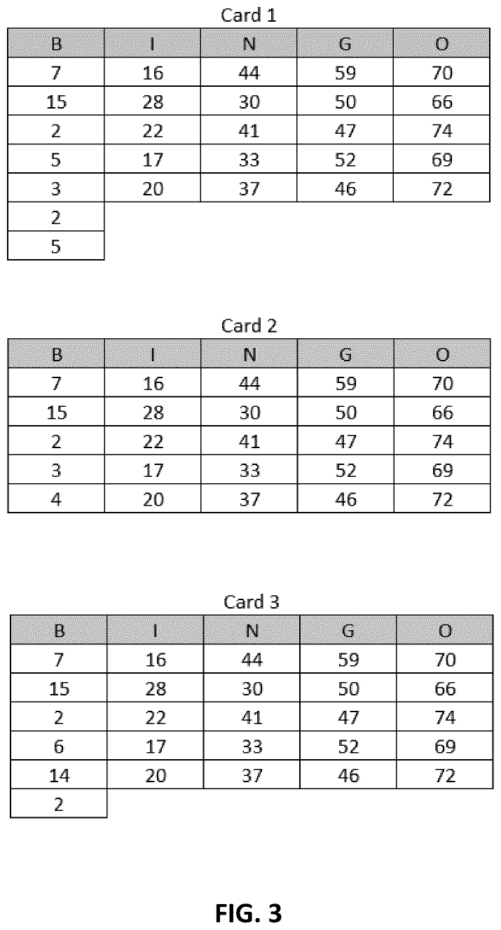

FIG. 3 illustrates an embodiment of a continuation award evaluation employing immaterial elements of the bingo game. In the example of FIG. 3, each bingo card has a varying color and/or shape. As seen in the illustrated embodiment, Card 1 shows a “color”=blue and a “B column count” of 7, Card 2 shows a “color”=orange and a “B column count” of 5, and Card 3 shows a “color”=orange and a “B column count” of 6.

As in the examples of FIGS. 1 and 2, a continuation award evaluation may be based on one or more of the immaterial elements. For example, a highest or lowest “B column count” may be awarded the continuation award, or a match between one of the immaterial elements and a match element (e.g., random number, random color, selected number, selected color, etc.) may form the basis for the continuation award evaluation. Additional continuation award evaluations may be employed, including more complex variations where elements of the bingo cards (whether essential, immaterial and/or supplemental) are mapped to results of one or more of a myriad of entertaining games, such as table games (i.e., one or more of poker, baccarat, blackjack, craps, roulette, a big six wheel or wheel of fortune, pool, pachinko, chemin de fer, pai gow, a lottery, keno, or any other table game or casino game, and the like).

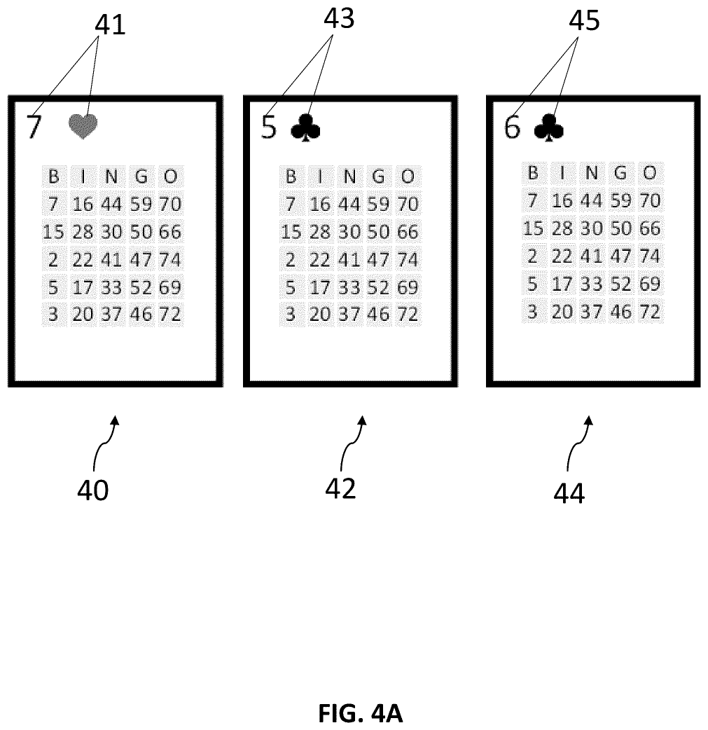

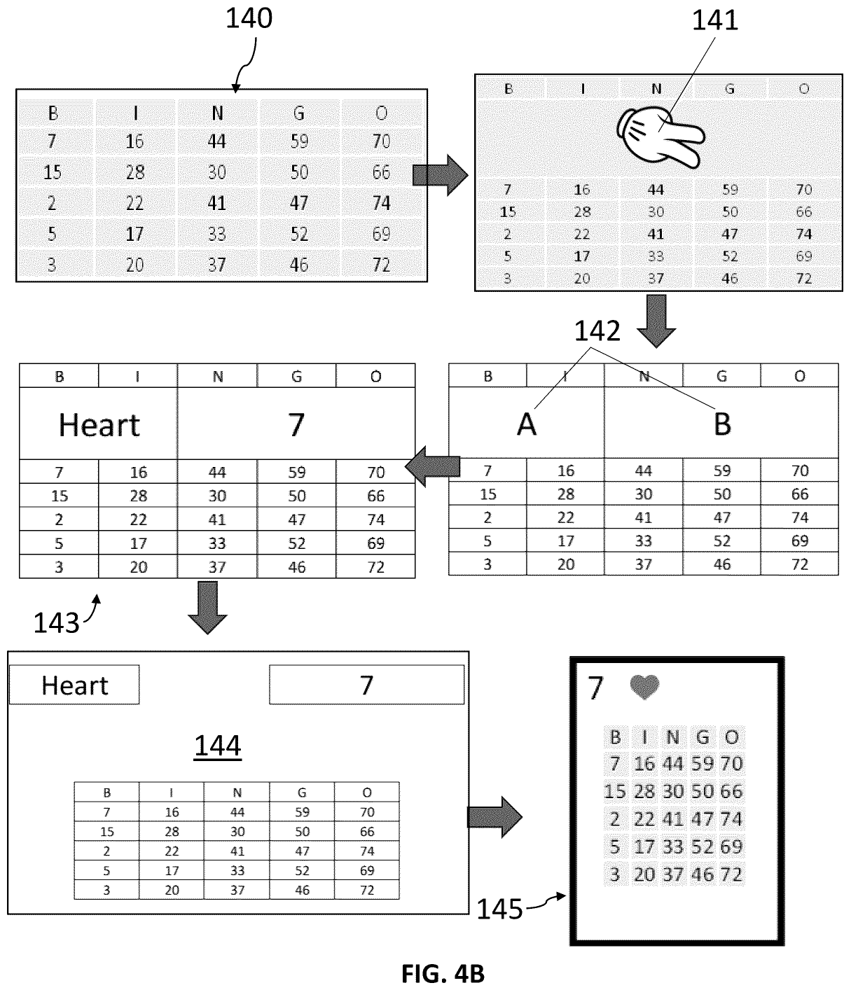

In one of the simplest embodiments according to the present disclosure, bingo cards may be provided with supplemental elements reflecting components of one or more of a myriad of entertaining games, such that a continuation award evaluation may be based on the sequential daubing of these supplemental elements. For example, FIG. 4A illustrates bingo cards 40, 42, 44 provided with supplemental elements 41, 43, 45 in the form of a number and suite of a traditional set of playing cards. In this manner, a continuation award evaluation may be based on any other game using traditional playing cards, such as blackjack, poker, war, etc.

Notably, an embodiment according to FIG. 4A may include multiple supplemental elements whereas the embodiments of FIG. 1 and FIG. 2 may in some configurations include only a single supplemental element for the continuation award evaluation. FIG. 4B includes a flow diagram of a possible modification of a bingo card to include multiple supplemental elements. Starting from a traditional bingo card 140, a single supplemental element may be added to the card, for example in the form of a scissors space 141 similar to the embodiments of FIG. 1 and FIG. 2. The single supplemental element may be expanded into two distinct supplemental elements 142 or spaces in the form of A and B. Now, A may be configured as one of four values (e.g., heart, spade, diamond, club) and B may be configured as a value between 1 and 13 (where 1=Ace, 2=2, . . . , 10=10, 11=Jack, 12=Queen, 13=King), giving an example like the illustrated bingo card 143. From this bingo card 143, the spaces of the bingo card may be rearrangeable 144 such that bingo cards may be provided having a familiar look to players with traditional elements from other games, e.g., table games, such as the bingo card 145 having an appearance of a traditional playing card.

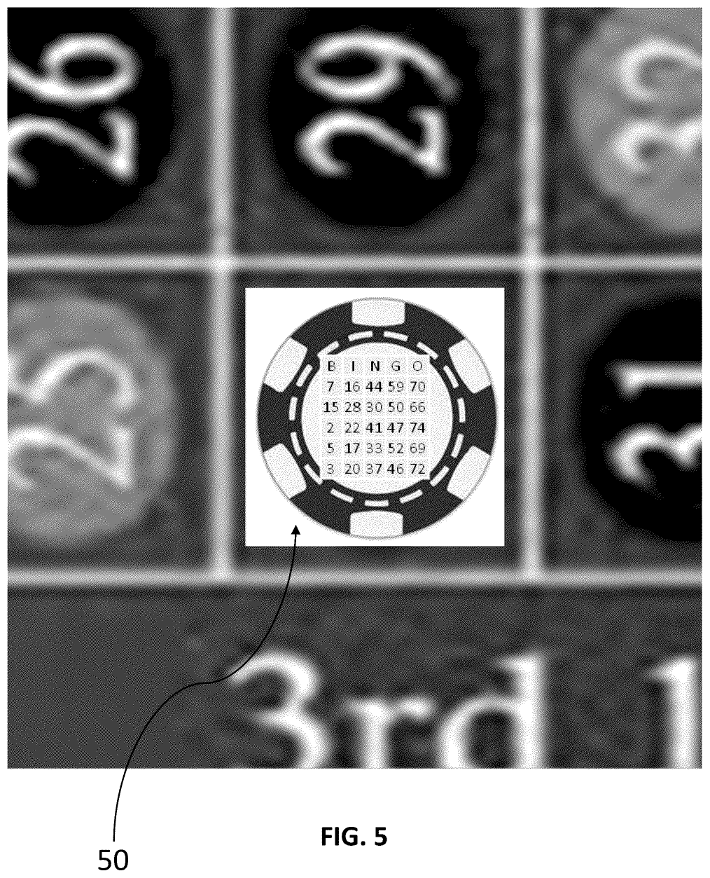

Additional embodiments may include supplemental elements corresponding to one or more other table games. For example, as shown in FIG. 5, a bingo card 50 may be provided including a supplemental element in the form of a Roulette chip. Alternatively, a bingo card may be provided including a supplemental element in the form of a space on a Roulette table. In this manner, a continuation award evaluation may be based on a Roulette game.

While the examples of FIG. 4A, FIG. 4B and FIG. 5 may include supplemental elements that may be independent of essential features of the bingo game, in alternative embodiments supplemental elements may be tied to or mapped to essential features of the bingo cards.

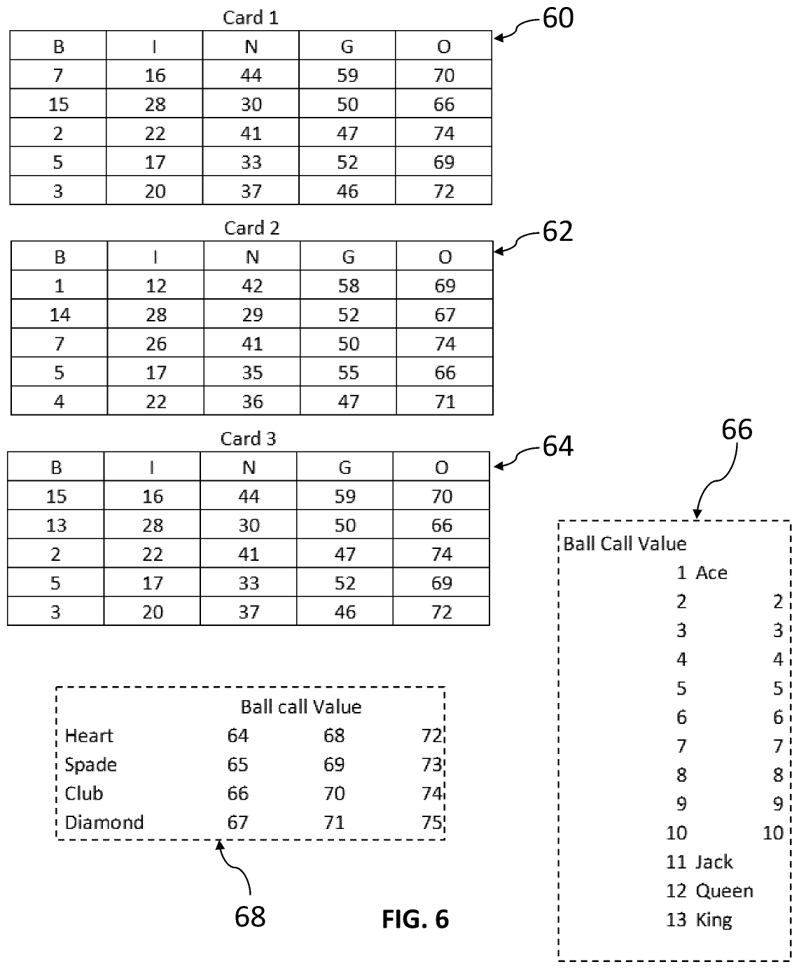

In one embodiment according to the illustration of FIG. 6, bingo cards 60, 62, 64 are mapped to playing cards using a rule set based on essential features of the bingo cards 60, 62, 64. In this example, the top most value in the “B” column (first column for a “B-I-N-G-O” column bingo card) that is less than fourteen is used to determine a number or rank of a corresponding playing card while a top most value in the “O” column that is greater than sixty-two is used to determine a suit of the corresponding playing card, based on a rank table 66 and a suite table 68. In the depicted example of FIG. 6, the first bingo card 60 is mapped to a seven of clubs, the second bingo card 62 is mapped to an ace of spades, and the third bingo card 64 is mapped to a king of clubs.

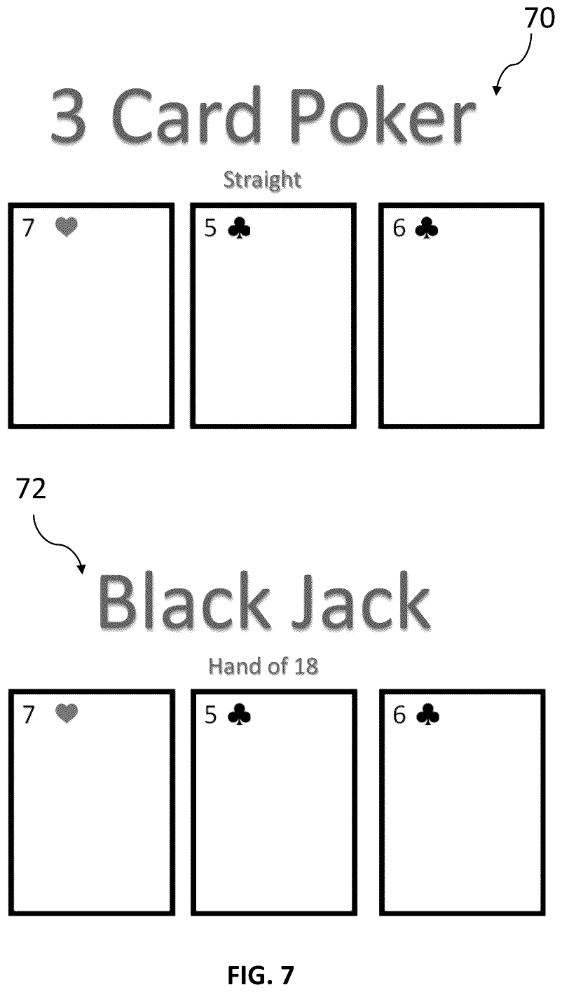

The playing cards may then be used in a continuation award evaluation for the bingo cards, such as a high card wins or low card wins award, and/or as part of a table game using traditional playing card values. For example, using a playing card hand according to FIG. 4A, the bingo cards may be employed in a table game such as in the form of a 3-card poker hand 70 or a blackjack hand 72, as illustrated in FIG. 7.

In some embodiments, a number, arrangement or other characteristic of the bingo cards and/or the ball call may be based on a desired continuation award evaluation. For example, a deck of bingo cards may be provided as a 52-card deck, each bingo card including a supplemental element corresponding to a playing card of a traditional 52-card deck of playing cards. Similar correspondence may be made between the bingo cards and/or the ball call and another table game or component of a table game. In this manner, a ball call according to varying embodiments may include a non-software random number generator, for example where distribution of the bingo cards from a shuffled deck of bingo cards having supplemental elements corresponding to playing cards may form the ball call. Similar implementations may be used with other hardware elements, for example comprising one or more of a physical dice roll where a face of the dice includes bingo card elements, a physical ball draw including bingo card elements, a physical spinning wheel or reel including bingo card elements, a physical roulette wheel including bingo card elements, a physical card draw from a physical deck of shuffled cards including bingo card elements, an analogue random number generator including bingo card elements, or another similar device or system.

While the above embodiments have been described with reference to physical bingo cards with physical elements, such as printed symbols, colors, etc., the current disclosure is not limited to such examples. One or more of the bingo cards and the corresponding essential, supplemental, and/or immaterial elements may be presented in a digital form, such as using a gaming machine or related device.

In varying examples, one or more of the bingo cards and the corresponding essential, supplemental, and/or immaterial elements may be projected onto a card or related component, such that one or more of the bingo game and the continuation award evaluation may be conducted using a computer system or related device. For example, a projector may be added to an existing table game, such as roulette, for projecting a bingo card in the form of a grid of bingo elements onto existing elements of the roulette game. In this manner, existing table games may be adapted into a bingo game with continuation award evaluations based on the elements from the table games being supplemental elements of the bingo cards. This may be accomplished by each space on a roulette table being associated with a bingo card projected thereon and becoming a supplemental element of said bingo card. Alternatively, the bingo card may be projected onto a chip used by the player on the roulette table, etc. In an alternative example, supplemental elements may be projected onto physical bingo cards by a projector, such as by projecting a value or number and suite of a playing card onto bingo cards provided on a table.

In another embodiment, one or more of the bingo cards and the corresponding essential, supplemental, and/or immaterial elements may be provided digitally, such as with a pointer object (i.e., number, QR code, barcode, symbol, etc.) to index to a corresponding virtual set of bingo cards and/or the corresponding essential, supplemental, and/or immaterial elements thereof. Such an arrangement allows for constant variability in the bingo cards available to a player.

Embodiments of a gaming system and related methods are further provided for conducting a wagering game including continuation award evaluations in addition to primary awards of a primary game of bingo, improving gameplay and management of class II games without losing the regulatory advantages associated with class II gaming. Further, the creation of new forms of gameplay for class II games is enabled, without increasing the processing requirements of a gaming terminal or gaming system.

The disclosed embodiments operate to improve how a gaming machine comprising a computing device operates and/or functions. For instance, the disclosed embodiments are able to automatically increase the variety and variability of rewards available for gaming while reducing management requirements by following the disclosed principles. Furthermore, the processing speed and operational efficiency of the gaming system can be improved. As a consequence, the disclosed embodiments operate to improve the computing efficiency and resource utilization of a gaming system and related computing architecture. As an additional example, by varying an entertaining display based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player.

Several (or different) elements discussed below, and/or claimed, are described as being “coupled”, “in communication with”, “in network communication”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

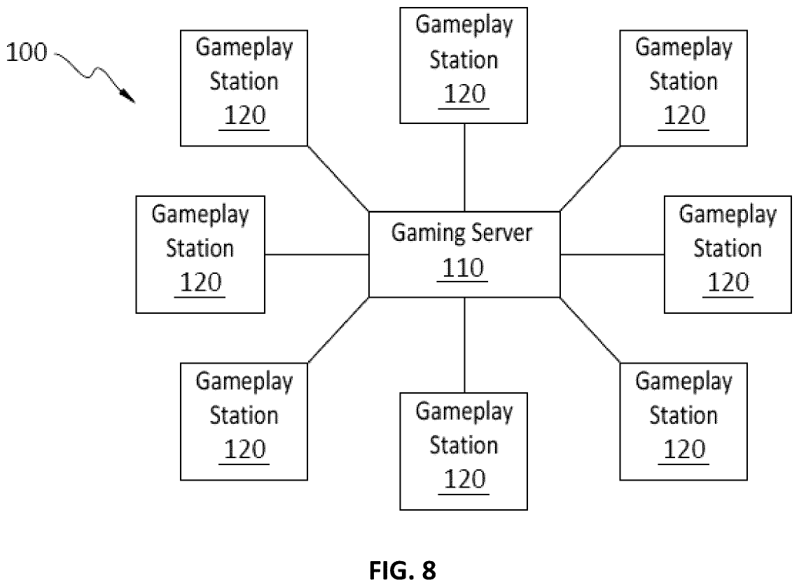

FIG. 8 illustrates an embodiment of a gaming system 100 including a gaming server 110 in communication with a plurality of gameplay stations 120 for enabling players to participate in gaming. The gaming system 100 may be configured to provide the gaming server 110 and the plurality of gameplay stations 120 in the same general location or may be configured to provide the gaming server 110 and the plurality of gaming stations 120 in remote locations.

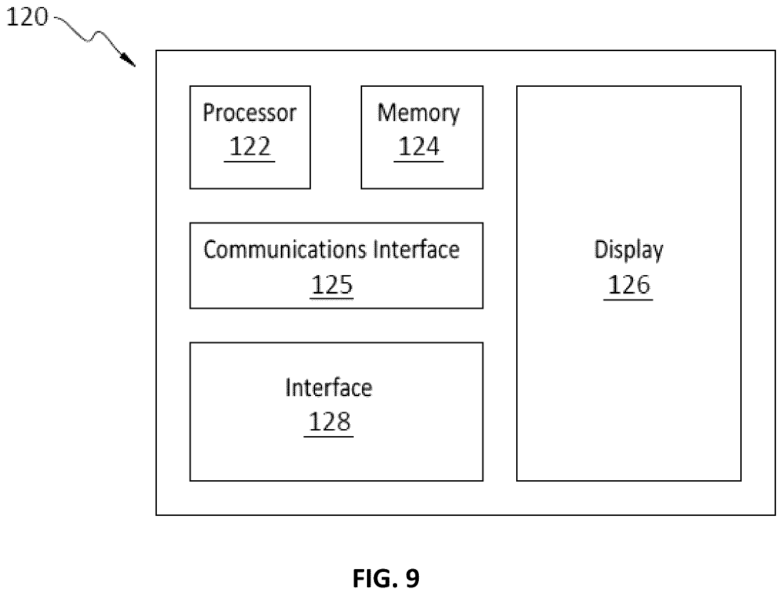

As illustrated in FIG. 9, each of the plurality of gameplay stations 120 may include a processor 122 and a memory 124 for operating a corresponding display 126 and a corresponding user interface 128. In operation, each gameplay station 120 is arranged to facilitate an input by a player, such that a corresponding gameplay request is sent by a communications interface 125 from the gameplay station 120 to the gaming server 110. The user interface 128 may include a keyboard, touch screen, card reader or other value receiving device, speakers, microphones, or any other suitable or related components.

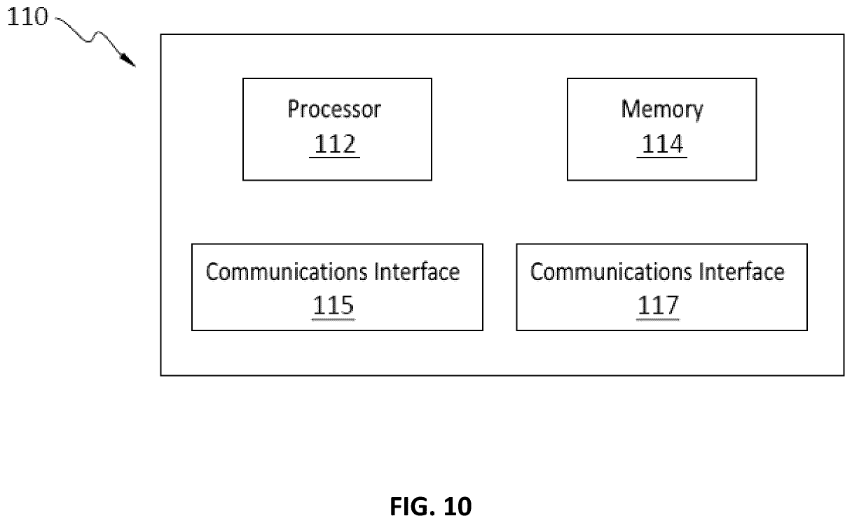

An embodiment of a gaming server 110 is shown in FIG. 10, including a processor 112, a memory 114 and a communications interface 115, for managing one or more games thereon. The gaming server 110 may be configured for receiving a gameplay request of a gameplay station 120 by means of the communications interface 115 and adding the gameplay request to a game.

According to various embodiments, the gaming server 110 may be provided with a communications interface 117 for remote management, maintenance or monitoring of the gaming system 100 and/or the communications interface 125 of the gameplay stations 120 may facilitate a local connection or may be provided as local communications interfaces. For example, communications interface 117, 125 may include an internet connection or other third-party data connection, such as for processing payments made by a player or for other communications.

According to alternative embodiments, the gameplay stations 120 and the gaming server 110 may be implemented in a single computing system, such that the gameplay stations 120 are integrated into a single device with or without the gaming server 110 also implemented thereon. In integrated embodiments, the gaming server 110 and the gameplay stations 120 may be operated using the same processor and/or the same memory with a plurality of user interfaces 128 and/or communications interfaces 115, 117, 125.

It is noted that one, more or each of the functions of a gaming server, central controller, central server or remote host as disclosed herein may be performed by one or more gameplay stations, such as by one or more processors of one or more gameplay stations. It is further noted that one, more or each of the functions of one or more gameplay stations as disclosed herein may be performed by the central gaming server, controller, central server or remote host.

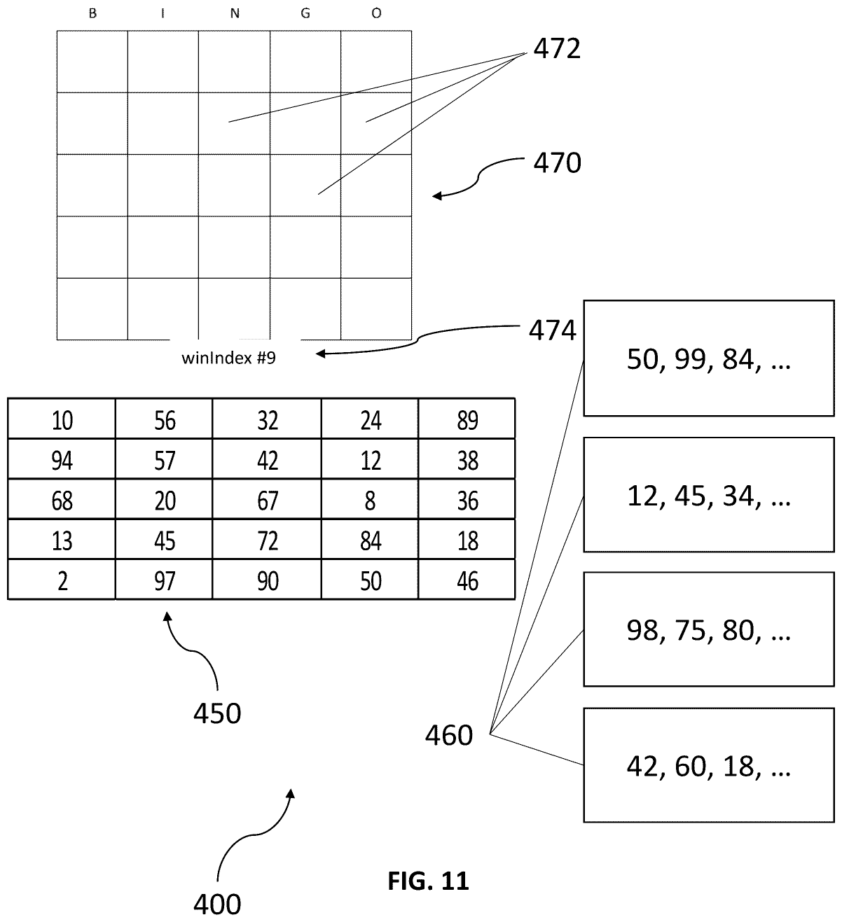

Embodiments of the disclosure may be directed to games facilitated as bingo games, as illustrated in FIG. 11. Accordingly, the gaming server 110 may comprise a bingo gaming server, such that the gaming server 110 creates and manages bingo games using gameplay requests received from the gameplay stations 120. Each gameplay request provided from a gameplay station 120 may include a card 450 including a different arrangement of tokens and supplemental elements, for example corresponding to a player's purchase of a card 450 through the user interface 128, and/or a wager amount. The player may initiate a game and may place a wager by any suitable method, such as by transferring money or credits to the gaming system 100. At least one or a plurality of input devices of the gaming system 100 may be used to facilitate the wager and the gaming system 100 may accept the wager.

The card 450 may include a random selection and arrangement of tokens from a token pool and may be selected from a plurality of cards 450 for assignment to the gameplay request or randomly generated for each gameplay request. For some embodiments, a continuation award evaluation may be specific to a card layout, such that the bingo cards may be provided in specific layouts and/or with specific tokens for defining supplemental elements of the cards, such that a continuation award evaluation may be based on the sequential daubing of these supplemental elements. According to varying embodiments, the gameplay request received by the gaming server may include a corresponding card 450 or may be assigned a card 450 upon receipt at the gaming server 110. Accordingly, a gameplay request may include a single card 450 or a plurality of cards 450 for use in a bingo game, such that each gameplay request may correspond to a single wager or a plurality of wagers for evaluation in a game.

Various forms of card assignment or selection may be used. The cards may take varying forms, including a random arrangement of any number of tokens, symbols, numbers or otherwise, such as in a grid pattern, a line or other arrangement. For some embodiments, a continuation award evaluation may be specific to a card layout, such that the bingo cards may be provided in specific layouts and/or with specific tokens for defining supplemental elements of the cards. The card 450 may be selected from a plurality of cards for assignment to the gameplay request or randomly generated for each gameplay request, such as using a random number generator.

In certain embodiments, a player may create or select a card by selecting a desired arrangement of specific tokens, supplemental elements or the like. In some examples, a card may have the form of a standard bingo card comprising numbers arranged in a 5-by-5 grid, but the embodiments are not limited thereto and may include cards of differing size and/or arrangements. While the card 450 may or may not be presented to a player in the display 126 of the gameplay station 120, the underlying card may be represented in a gameplay request 450 communicated to or assigned by the gaming server 110 in a digital, numerical, referential or other form.

In embodiments, the assignment or selection of a card may be limited to prevent the same card being used in the same game. For example, assignment or selection of a card may be restricted to only cards that have not yet been used in a game. In an alternative embodiment, assignment of a gameplay request to an existing game may be made by taking into account whether a card of the gameplay request has been used in said existing game previously, such that a card can be used only once for an associated call or game. Alternatively, for example where a card is randomly generated or selected for each gameplay request, identical cards may occur.

In addition to the assignment or selection of a card, the gameplay request may include a wager amount as input by a player. In varying forms of the gaming system, the player may select a predefined wager or enter a custom wager using the user interface 128, for example by means of a card reader or other reader for receiving objects of value. The wager may accompany the gameplay request to the gaming server or be retained in the gameplay station, for communication or resolution after a result of a given card is determined.

In one aspect of the disclosure, the gaming server 110 of the system 100 may include databases, terminals, and computing devices to manage one or more wager pot pools in a wager pot wagering environment. In certain aspects, the gaming server 110 may employ a wager pot processing system for accepting and processing wagers of one or more players, making wager pot pool allocations, calculating odds and prices of wagers, calculating the commission for the operator, and distributing winnings. Rewards may be distributed to players based on a predetermined score sheet including one or more essential elements of the bingo cards, immaterial elements of the bingo cards, supplemental elements of the bingo cards, specified patterns, calls, and/or award levels that are associated with a wager pot pool of the wager pot processing system. The gaming server 110 may maintain separate math models and separate wager pot pools for different wager denominations, specified patterns, calls, and/or wager levels based on one or more essential, immaterial and/or supplemental elements of the bingo cards offered by each model.

Each game 460 on the gaming server 110 may include a call 460, for example including randomly selected tokens from a token pool, such that the gaming server 110 compares the gameplay request 450 or card of the player to a call or game 460. In certain aspects, the call or game 460 may be pending on the gaming server 110 before the gameplay request 450 is received or created in response to the gameplay request 450. The gaming server 110 may further select a game call or ball call 460, including randomly selected tokens from a token pool or a randomly selected grouping of tokens, such as using a random number generator.

When the tokens on the player's card matching the call of the game 460 form one of a plurality of certain predetermined patterns or arrangements, the card of the gameplay request 450 may be identified as a winner and may be scored against a predetermined score sheet such that a principal result with a corresponding reward may be disbursed to the player at the gameplay station 120. Continuation award evaluations may be conducted before, after, in addition to, or in place of a scoring of the player's tokens according to said plurality of certain predetermined patterns or arrangements, the continuation award evaluation including awards assessed utilizing sequential daubing of essential (i.e., numbers, patterns, daubs, etc.) and/or immaterial (i.e., color of card, shape of matching area, number of card, etc.) and/or supplemental (i.e., additional attributes of the ball call and/or bingo card such as added number, symbols, colors, etc.) elements of the bingo game. The continuation award evaluations may be distinct and independent from the principal result of the result index, score sheet, and/or from the end of the bingo game. Alternatively, when the tokens on the player's card matching the call of the game 460 do not form one of the plurality of predetermined patterns or arrangements and the continuation award evaluation does not result in an award, the gameplay request 450 may be discarded and the principal result may not include a reward being provided to the player.

To define a score sheet 470 according to an embodiment of the current disclosure, the processor may consider specific patterns of matched or daubed tokens 472 relative to a size, shape, and/or layout of the cards. A reward 474 may be tied to matching only a specified pattern without any additional tokens being daubed (i.e., requiring that both positive daubs and non-daubs are matched) or to matching the specified pattern regardless of other tokens being daubed (i.e., requiring only that positive daubs are matched). In various embodiments, the score sheet may be defined by a pattern and by a number of balls called to match the pattern. Different patterns and/or a number of balls needed to match the pattern may be included in the score sheet 470 and may be tied to different award levels 474. While described as a score sheet 470, varying embodiments may employ other approaches to evaluate a gameplay request or wager. As such, no specific architecture is required for evaluating a player's gameplay request or wager.

The player's card 450 may be submitted to the server 110 for evaluation of a continuation award and/or comparison to the ball call 460 and/or the score sheet 470 of the gaming system 100 or may be evaluated at a gameplay station 120. In varying embodiments, the score sheet may include a pay table wherein the pay table may identify which patterns are available for comparison to the player's card based on the wager provided by the player. If there is an available pattern that is a match with the card of the player based on the corresponding ball call of the game, a principal result of the corresponding wager may be used to determine the reward associated with the score sheet 470. The score sheet 470 may provide static rewards for the predetermined patterns and/or may be dynamically adjusted based on the circumstances of the game and/or the gaming system.

The gaming system may create and/or select an entertaining display corresponding to the principal result of the player's wager, based on the continuation award evaluation and/or whether a pattern is found that is a match with the card of the player based on the corresponding ball call of the game, which pattern was a match, how many balls were required before the match, and/or the reward value won. The entertaining display may break the value won into multiple animations or bonus games. Breaking the value won into multiple animations or bonus games can increase the enjoyment and successful feeling of the player and encourage continued gaming.

In some embodiments, the entertaining display may include a separate component (not shown), such as a separate display screen or mechanical element. The separate components may include a video display, window or a mechanical element corresponding to a plurality of possible results of the player's wager. During the presentation of the entertaining display, a portion of the gaming device may remain dedicated to illustrating features of the bingo game 400.

The entertaining display may be based on a theme or a secondary game. The theme or secondary game may be selected by a player based on preference and/or may be manipulated by the processor in response to a particular continuation award evaluation, principal result of a wager and/or a reward value available for a wager. The theme or secondary game may include accompanying depictions and animated highlights of a winning game as the participants complete the wager. The entertaining display may include matches with graphics, symbols, and other indicia particular to the theme or the secondary game.

The wager may end with a payout, beginning another wager, another round, a bonus game, and/or by reverting to a menu providing additional options for the player.

By providing a gaming system and method for using the same according to the disclosed embodiments, the gaming system embodiments provided herein advantageously allow a prospective player to play a bingo game with variable and dynamic reward values and gameplay, thereby increasing a player's enjoyment of the gaming machine generally, while meeting the regulatory requirements and retaining the advantages of class II gaming.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

Accordingly, features of the disclosed embodiments may be combined or arranged for achieving particular advantages. Similarly, features of the disclosed embodiments may provide independent benefits applicable to other examples not detailed herein.

It is to be understood that not necessarily all objects or advantages may be achieved under any embodiment of the disclosure. The disclosed gaming system and related methods may be embodied or carried out in a manner that achieves or optimizes one advantage or group of advantages as taught without achieving other objects or advantages as taught or suggested.

The various features described herein can be combined interchangeably. Besides the variations described, other known equivalents for various features can be mixed and matched to make or use a gaming system and related methods under principles of the present disclosure. The features described may be adapted to other types of systems, games and regulatory requirements.

Although this disclosure describes certain exemplary embodiments and examples of a gaming system and related methods, the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1. A gaming system comprising: one or more gameplay stations, the gameplay stations including a user interface; and a gaming server in communication with the one or more gameplay stations through a communications interface, the gaming server comprising a memory and a processor configured for executing instructions stored on the memory to perform the following steps: receive a gameplay request from at least one of the one or more gameplay stations; evaluate a continuation award for the gameplay request based on one or more of essential, immaterial, and/or supplemental elements of a bingo card; and determine an award value for the gameplay request based on the continuation award evaluation.

2. The gaming system of any one or a combination of two or more of 1 above and 3-10 below, wherein the gameplay request comprises at least a bingo card and a bingo call.

3. The gaming system of any one or a combination of two or more of 1-2 above and 4-10 below, wherein the essential, immaterial, and/or supplemental elements of the bingo card include one or more of a size, color, and/or layout of the bingo card.

4. The gaming system of any one or a combination of two or more of 1-3 above and 5-10 below, wherein the essential, immaterial, and/or supplemental elements of the bingo card include one or more of a playing card suite and a playing card value.

5. The gaming system of any one or a combination of two or more of 1-4 above and 6-10 below, wherein the essential, immaterial, and/or supplemental elements of the bingo card include one or more of a roulette space and a roulette chip.

6. The gaming system of any one or a combination of two or more of 1-5 above and 7-10 below, wherein the essential, immaterial, and/or supplemental elements of the bingo card include one or more of a rock-paper-scissors element.

7. The gaming system of any one or a combination of two or more of 1-6 above and 8-10 below, wherein the essential, immaterial, and/or supplemental elements of the bingo card are compared to a match element in the continuation award evaluation.

8. The gaming system of any one or a combination of two or more of 1-7 above and 9-10 below, wherein the gameplay request further comprises a wager value.

9. The gaming system of any one or a combination of two or more of 1-8 above and 10 below, wherein the continuation award evaluation does not end the gameplay request; wherein the gameplay request ends when a game ending pattern occurs.

10. The gaming system of any one or a combination of two or more of 1-9 above, wherein evaluating the continuation award for the gameplay request is based on a sequential daubing of one or more of essential, immaterial, and/or supplemental elements of a bingo card.

11. A method for conducting games, comprising: receiving a gameplay request from one or more gameplay stations; evaluating a continuation award for the gameplay request based on one or more of essential, immaterial, and/or supplemental elements of a bingo card; and determining an award value for the gameplay request based on the continuation award evaluation.

12. The method of any one or a combination of two or more of 11 above and 13-20 below, wherein the gameplay request comprises at least a bingo card and a bingo call.

13. The method of any one or a combination of two or more of 11-12 above and 14-20 below, wherein the essential, immaterial, and/or supplemental elements of the bingo card include one or more of a size, color, and/or layout of the bingo card.

14. The method of any one or a combination of two or more of 11-13 above and 15-20 below, wherein the essential, immaterial, and/or supplemental elements of the bingo card include one or more of a playing card suite and a playing card value.

15. The method of any one or a combination of two or more of 11-14 above and 16-20 below, wherein the essential, immaterial, and/or supplemental elements of the bingo card include one or more of a roulette space and a roulette chip.

16. The method of any one or a combination of two or more of 11-15 above and 17-20 below, wherein the essential, immaterial, and/or supplemental elements of the bingo card include one or more of a rock-paper-scissors element.

17. The method of any one or a combination of two or more of 11-16 above and 18-20 below, wherein the essential, immaterial, and/or supplemental elements of the bingo card are compared to a match element in the continuation award evaluation.

18. The method of any one or a combination of two or more of 11-17 above and 19-20 below, wherein the gameplay request further comprises a wager value.

19. The method of any one or a combination of two or more of 11-18 above and 20 below, wherein the continuation award evaluation does not end the gameplay request.

20. The method of any one or a combination of two or more of 11-19 above, wherein the gameplay request ends when a game ending pattern occurs.

21. A storage device having instructions stored thereon, which, when executed by one or more processors of a gaming system, configure the one or more processors to perform the method according to any one or a combination of two or more of 11-20 above.

21. A set of bingo cards comprising a grid of bingo tokens and one or more supplemental elements for enabling a continuation award evaluation.

22. The set of bingo cards according to 21 above, wherein the supplemental elements comprise a component of a table game.

23. The set of bingo cards according to 21, a playing card, a casino chip, a roulette number, a color, and/or another feature of a table game, wherein the supplemental elements of each bingo card are different.

1. A gaming system comprising:
one or more gameplay stations, the gameplay stations including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate a continuation award for the gameplay request based on one or more of essential, immaterial, and/or supplemental elements of a bingo card; and
determine an award value for the gameplay request based on the continuation award evaluation.

2. The gaming system according to claim 1,
wherein the gameplay request comprises at least a bingo card and a bingo call.

3. The gaming system according to claim 1, wherein the essential, immaterial, and/or supplemental elements of the bingo card include one or more of a size, color, and/or layout of the bingo card.

4. The gaming system according to claim 1, wherein the essential, immaterial, and/or supplemental elements of the bingo card include one or more of a playing card suite and a playing card value.

5. The gaming system according to claim 1, wherein the essential, immaterial, and/or supplemental elements of the bingo card include one or more of a roulette space and a roulette chip.

6. The gaming system according to claim 1, wherein the essential, immaterial, and/or supplemental elements of the bingo card include one or more of a rock-paper-scissors element.

7. The gaming system according to claim 1, wherein the essential, immaterial, and/or supplemental elements of the bingo card are compared to a match element in the continuation award evaluation.

8. The gaming system according to claim 1, wherein the gameplay request further comprises a wager value.

9. The gaming system according to claim 1, wherein the continuation award evaluation does not end the gameplay request;
wherein the gameplay request ends when a game ending pattern occurs.

10. The gaming system according to claim 1, wherein evaluating the continuation award for the gameplay request is based on a sequential daubing of one or more of essential, immaterial, and/or supplemental elements of a bingo card.

11. A method for conducting games, comprising:
receiving a gameplay request from one or more gameplay stations;
evaluating a continuation award for the gameplay request based on one or more of essential, immaterial, and/or supplemental elements of a bingo card; and
determining an award value for the gameplay request based on the continuation award evaluation.

12. The method according to claim 11, wherein the gameplay request comprises at least a bingo card and a bingo call.

13. The method according to claim 11, wherein the essential, immaterial, and/or supplemental elements of the bingo card include one or more of a size, color, and/or layout of the bingo card.

14. The method according to claim 11, wherein the essential, immaterial, and/or supplemental elements of the bingo card include one or more of a playing card suite and a playing card value.

15. The method according to claim 11, wherein the essential, immaterial, and/or supplemental elements of the bingo card include one or more of a roulette space and a roulette chip.

16. The method according to claim 11, wherein the essential, immaterial, and/or supplemental elements of the bingo card include one or more of a rock-paper-scissors element.

17. The method according to claim 11, wherein the essential, immaterial, and/or supplemental elements of the bingo card are compared to a match element in the continuation award evaluation.

18. The method according to claim 11, wherein the gameplay request further comprises a wager value.

19. The method according to claim 11, wherein the continuation award evaluation does not end the gameplay request.

20. The method according to claim 11, wherein the gameplay request ends when a game ending pattern occurs.
